(19) United States
(12) Patent Application Publication
(10) Pub. No.: US 2018/0359335 A1
(43) Pub. Date: Dec. 13, 2018

(54) COOPERATIVE POLICY-DRIVEN CONTENT PLACEMENT IN BACKHAUL-LIMITED CACHING NETWORK

(71) Applicant: IDAC Holdings, Inc., Wilmington, DE (US)

(72) Inventors: Hongfei Du, Woking (GB); Dirk Trossen, London (GB)

(73) Assignee: IDAC Holdings, Inc., Wilmington, DE (US)

(21) Appl. No.: 15/781,290

(22) PCT Filed: Dec. 2, 2016
(86) PCT No.: PCT/US2016/064542

§ 371 Date: Jun. 4, 2018

Related U.S. Application Data
(60) Provisional application No. 62/263,125, filed on Dec. 4, 2015.

(51) Int. Cl. H04L 29/08; H04L 12/24; H04L 29/06

(52) U.S. Cl. CPC H04L 67/2852; H04L 65/102; H04L 67/2847; H04L 41/0893

(57) ABSTRACT

Systems, methods, and instrumentalities are disclosed for a cooperative policy-driven content placement and/or retrieval in a backhaul-limited caching network. A policy request may be received from a policy client. An edge cache server for storing content may be determined based on at least one of an average latency, a backhaul bandwidth, a peak time table, and/or a residual storage capacity associated with the edge cache server. A time for pre-fetching content may be determined based on network usage statistics. The network usage statistics may include a historical peak time table. The content may be pre-fetched to the edge cache server at the determined time. The content may be retrieved by an access client from one or more edge cache servers in an organized manner. For example, the content may be sent to an access client from the edge cache server.

### CROSS REFERENCE TO RELATED APPLICATIONS

This application claims priority to and the benefit of the filing date of U.S. provisional application No. 62/263,125, which is hereby incorporated by reference as if fully set forth herein.

### BACKGROUND

With the reduction in price and size of data-storage devices, cache-enabled servers may be implemented in a network. For example, the cache-enabled servers may be implemented at the edge of the network. The cache-enabled servers may be used to store popular content and deliver the content to a user when requested. The content may be delivered to the user without consuming the bandwidth of the backhaul connection. Research efforts have addressed the challenge of providing affordable Internet access to those who cannot afford it. For example, the EU H2020 RIFE efforts address the technological challenge of increasing the efficiency of the underlying transport networks and the involved architectures and protocols.

### SUMMARY

Systems, methods, and instrumentalities are disclosed for a cooperative policy-driven content placement and/or retrieval in a backhaul-limited caching network. A policy request may be received from a policy client. An edge cache server for storing content may be determined based on at least one of an average latency, a backhaul bandwidth, a peak time table, and/or a residual storage capacity associated with the edge cache server. A time for pre-fetching content may be determined based on network usage statistics. The network usage statistics may include a historical peak time table. The content may be pre-fetched to the edge cache server at the determined time. The content may be retrieved by an access client from one or more edge cache servers in an organized manner. For example, the content may be sent to an access client from the edge cache server.

A method of managing content caching from a plurality of edge servers may include one or more of (i) receiving a content request; (ii) determining a policy, for access clients to retrieve the requested content, from the plurality of edge servers, based on one of a requested cache storage, a retention period for the requested content, a URL for the requested content, and the access clients for the requested content; (iii) receiving, from each of the plurality of edge servers, latency data, a backhaul bandwidth, a peak usage time, and a residual storage capacity for the respective edge sever; (iv) determining to store the requested content on at least one of the plurality of edge servers based on at least one of the received policy request, the received latency data, the received backhaul bandwidth, the received peak usage time, a historical peak data usage over time of day, and the received residual storage capacity; (v) determining a prefeteching time, for the at least one of the plurality of edge servers that was determined to store the requested content, to prefetch the requested content, from a server or network; and (vi) determining a prefetching bandwidth, for the at least one of the plurality of edge servers that was determined to store the requested content, to prefetch the requested content from the server or network. The method may take place in content placement controller, policy client, policy manager, or some combination of a content placement controller, policy client, and policy manager.

Receiving the content request may include receiving the content request from a user input.

The method may include determining that one of the plurality of edge servers is a main content cache server for the access clients and one or more of the plurality of edge servers is a voluntary content cache for the access clients and may further include determining that the main contact cache sever is the edge server in the plurality of edge severs that has a shortest average latency among the plurality of edge servers.

The method may include determining a refreshment profile, for the at least one of the plurality of edge servers that was determined to store the requested content, based on at least one of a number of users, a requested size, a cache size, one or more backhaul resources, a latency of one or more subscriber clients, a historical peak time table, and/or requests to download the requested content.

The method may include, for each access client, determining to store the requested content on at least one of the plurality of edge servers based on at least one of the received policy request, the received latency data, the received backhaul bandwidth, the received peak usage time, a historical peak data usage over time of day, and the received residual storage capacity; determining a prefetching time, for the at least one of the plurality of edge servers that was determined to store the requested content, to prefetch the requested content, from a server or network; and determining a prefetching bandwidth, for the at least one of the plurality of edge servers that was determined to store the requested content, to prefetch the requested content from the server or network.

The method may include determining a prefetching time based on an available backhaul bandwidth for the at least one of the plurality of edge servers that was determined to store the received content.

The method may include determining a prefetching bandwidth based on at least one of backhaul bandwidth and cache storage size for the at least one of the plurality of edge servers that was determined to store the received content.

A computing system (e.g., server(s), computer(s), network(s)) for managing content caching from a plurality of edge servers may include one or more processors configured for (e.g., being programmed with executable instructions or hardware for) one or more of (i) receiving a content request; (ii) determining a policy, for access clients to retrieve the requested content, from the plurality of edge servers, based on one of a requested cache storage, a retention period for the requested content, a URL for the requested content, and the access clients for the requested content; (iii) receiving, from each of the plurality of edge servers, latency data, a backhaul bandwidth, a peak usage time, and a residual storage capacity for the respective edge sever; (iv) determining to store the requested content on at least one of the plurality of edge servers based on at least one of the received policy request, the received latency data, the received backhaul bandwidth, the received peak usage time, a historical peak data usage over time of day, and the received residual storage capacity; (v) determining a prefeteching time, for the at least one of the plurality of edge servers that was determined to store the requested content, to prefetch the requested content, from a server or network; and (vi) determining a prefetching bandwidth, for the at least one of the plurality of edge servers that was determined to store the requested content, to prefetch the requested content from the server or network. The computing system may be a content placement controller, a policy client, a policy manager, or some combination of a content placement controller, a policy client, and a policy manager.

The one or more processors may be further configured to receive the content request from a user input.

The one or more processors may be further configured to determine that one of the plurality of edge servers is a main content cache server for the access clients and one or more of the plurality of edge servers is a voluntary content cache for the access clients and may further be configured to determine that the main contact cache sever is the edge server in the plurality of edge severs that has a shortest average latency among the plurality of edge servers.

The one or more processors may be further configured to determine a refreshment profile, for the at least one of the plurality of edge servers that was determined to store the requested content, based on at least one of a number of users, a requested size, a cache size, one or more backhaul resources, a latency of one or more subscriber clients, a historical peak time table, and/or requests to download the requested content.

The one or more processors may be further configured, for each access client, determine to store the requested content on at least one of the plurality of edge servers based on at least one of the received policy request, the received latency data, the received backhaul bandwidth, the received peak usage time, a historical peak data usage over time of day, and the received residual storage capacity; determine a prefetching time, for the at least one of the plurality of edge servers that was determined to store the requested content, to prefetch the requested content, from a server or network; and determine a prefetching bandwidth, for the at least one of the plurality of edge servers that was determined to store the requested content, to prefetch the requested content from the server or network.

The one or more processors may be further configured to determine a prefetching time based on an available backhaul bandwidth for the at least one of the plurality of edge servers that was determined to store the received content.

The one or more processors may be further configured to determine a prefetching bandwidth based on at least one of backhaul bandwidth and cache storage size for the at least one of the plurality of edge servers that was determined to store the received content.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and an example core network that may be used within the communications system illustrated in FIG. 1A.

FIG. 1E is a system diagram of another example radio access network and an example core network that may be used within the communications system illustrated in FIG. 1A.

FIG. 2 depicts an example policy-driven system architecture.

FIG. 3 depicts an example policy-driven edge content placement.

FIG. 4 depicts an example content placement.

FIG. 5 depicts an example historical peak time table for a policy-driven caching design.

FIG. 6 depicts an example operational message exchange chart of cooperative content.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

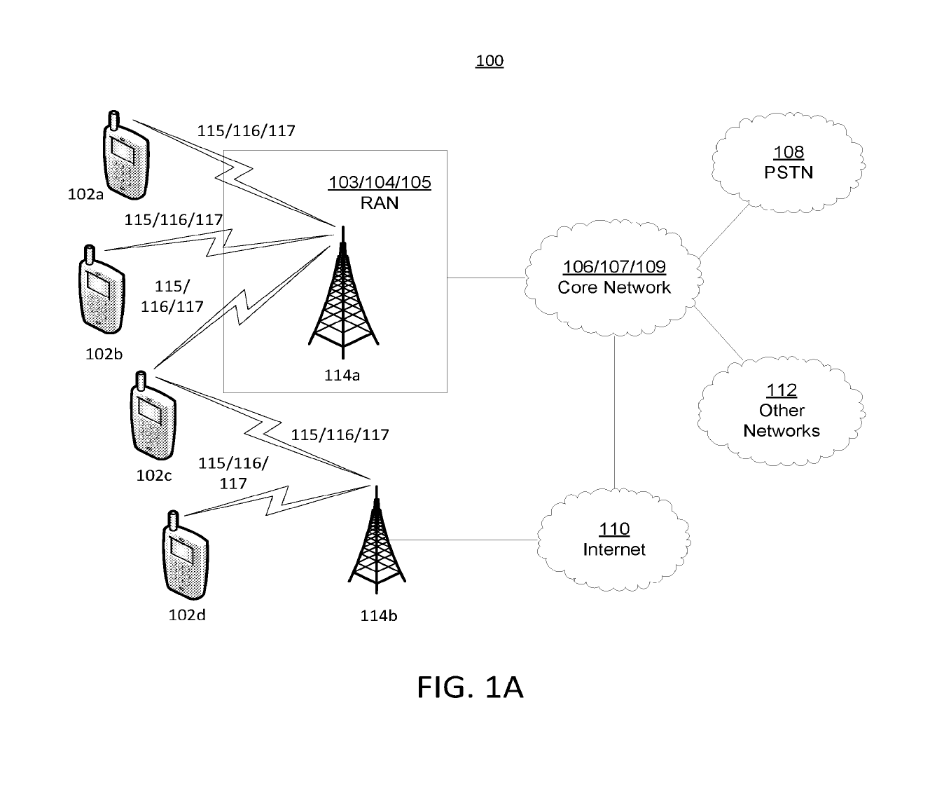

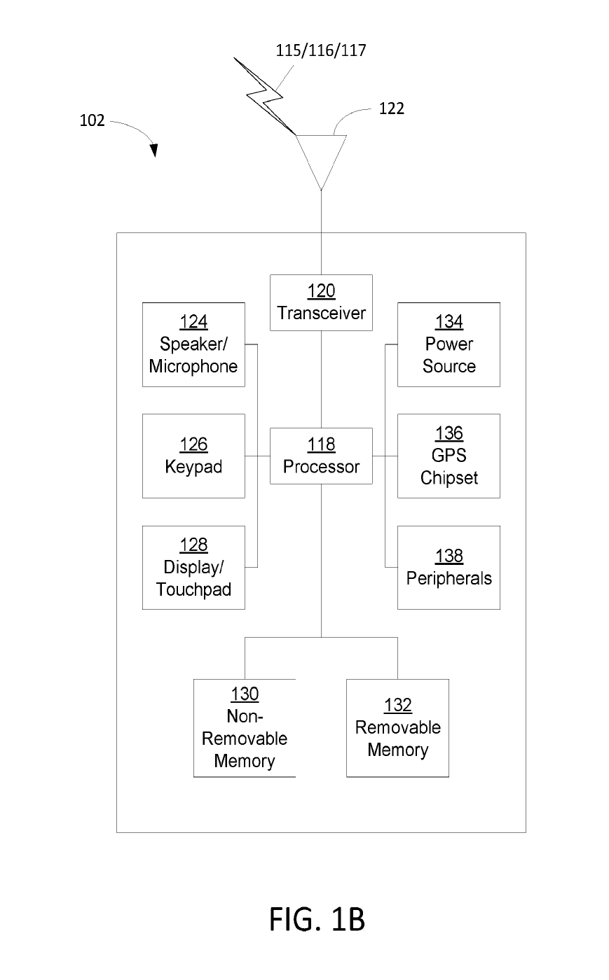

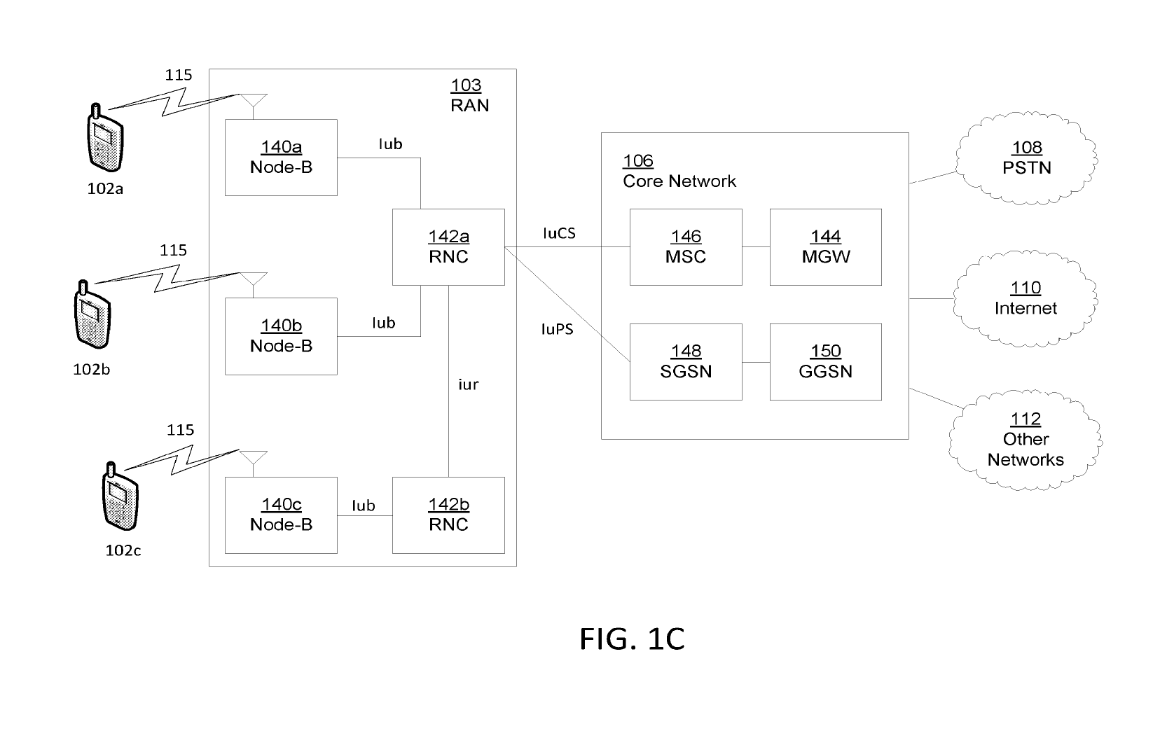

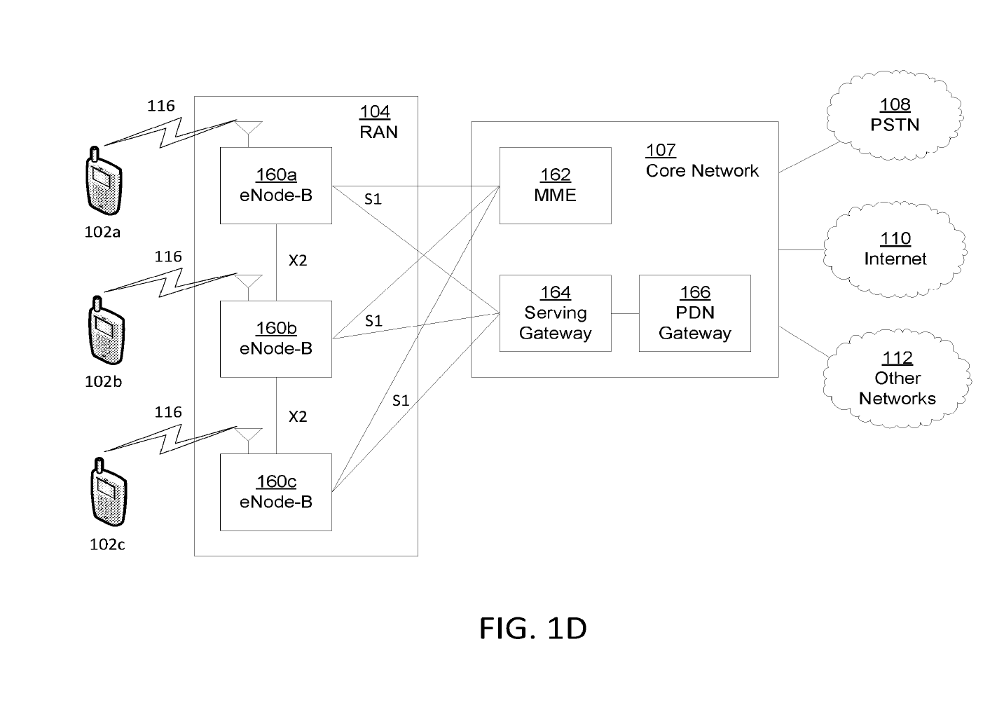

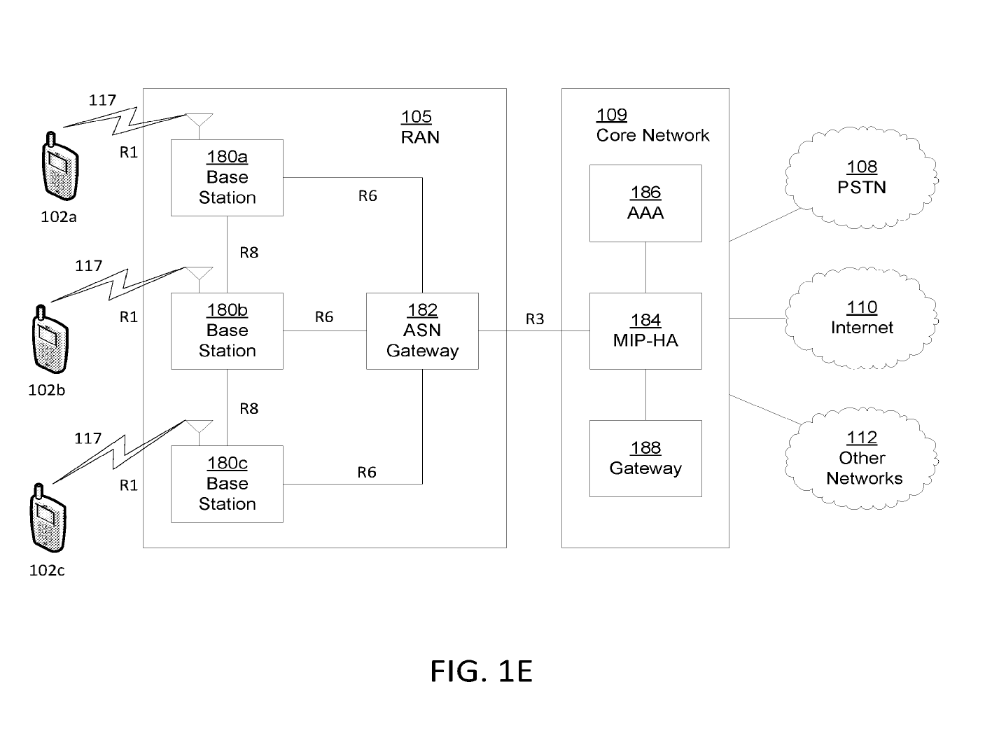

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any subcombination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

A policy-driven edge cache content placement may be provided. For example, a system architecture, interface(s), and/or implementations associated with performing a policy-driven edge cache content placement may be provided. These may be associated with situations where limited backhaul capacity exists. A multi-profile criteria may be defined. For example, a multi-profile criteria may be defined to set one or more refreshment patterns at one or more edge caches. The one or more refreshment patterns may be associated with one or more constraints. The one or more constraints may include a cache capacity and/or a backhaul bandwidth limitation. A policy-driven content retrieval may be provided.

A network may include one or more edge cache servers. An edge cache server may be associated with a constrained backhaul bandwidth and/or a storage capacity. Policy content may be requested (e.g., by an access client and/or a web-based management console). The requested policy content may be pre-fetched (e.g., based on multiple criteria) to one or more edge caching servers from, for example, a network or server. The one or more edge caching servers may provide content offloading. For example, content may be offloaded from the backhaul network to the one or more edge caching servers. For example, the one or more edge caching servers may provide content offloading when the policy content is requested during a retention time period. One or more content placement rules may be defined. A content placement controller (CPC), policy server, or a combined CPC and policy server may determine the one or more content placement rules (e.g., via predefined refreshment patterns that control the content caching behavior of respective caches). Unused residual spare capacity and/or backhaul bandwidth of an edge cache server may be used (e.g., to improve a quality of experience (QoE) of one or more end users and/or alleviate congestion in the backhaul connection). The QoE of an end user may include a user perceived latency and/or response time.

A policy-driven system architecture may include a content placement controller (CPC) node. The CPC node may receive a policy request from a policy client (e.g., a policy server or from a user). Policy client, policy server, and policy manager are used synonymously except where stated otherwise. The CPC node may derive one or more refreshment patterns. The CPC node may coordinate and/or manage one or more edge cache servers (ECS) throughout the network.

The policy-driven system architecture may include one or more interfaces between a policy client and a CPC. The one or more interfaces may be used to receive and/or confirm a policy request and/or response. The policy-driven system architecture may include one or more interfaces between a CPC and an ECS. The one or more interfaces between the CPC and the ECS may be used to apply a refreshing instruction received from the CPC. The policy-driven system architecture may include one or more interfaces between an ECS and a backhaul. The one or more interfaces between the ECS and the backhaul may be used to receive network available bandwidth and/or channel state information. The policy-driven system architecture may include one or more interfaces between an ECS and an access client. The one or more interfaces between the ECS and the access client may be used to receive a latency state (e.g., an instantaneous latency state) of a link between the ECS and the access client. The one or more interfaces between the ECS and the access client may be used to upload content to the ECS.

A policy submission for a fronthaul network and its entities may be provided. A CPC may request information from one or more policy clients (e.g., a policy server or from a user). The information requested by the CPC from the one or more policy clients (e.g., a policy server or from a user) may include URL sets, a start time, a retention time, a user list, and/or a requested size. Where the policy server and the CPC are separate or combined, the policy server may receive the information from a user.

A peak time knowledge space table may be provided to the CPC, policy server, or a combined CPC and policy server. The peak time knowledge space table may enable a CPC or policy server to derive an intelligent assignment of an allowed pre-fetching period for one or more ECS.

A refreshment profile may be determined, for example, by considering one or more of a number of files, a number of users, a requested size, a cache size, one or more backhaul resources, a latency of one or more subscriber clients, a historical peak time table, and/or a content popularity by a CPC, a policy server, or a combined CPC and policy server.

As part of a content placement, a main supplier cache may be assigned by a CPC, a policy server, or a combined CPC and policy server. The main supplier cache may include a shortest average latency to one or more access clients. The content placement may assign a voluntary supplier cache (e.g., by utilizing a residual spare capacity from one or more nearby caches). A demand from a user may be accommodated by the main supplier cache (e.g., without duplicate transmissions from remote servers). The demand may be accommodated in terms of an improved QoE by a voluntary supplier cache (e.g., where redundant traffic between one or more subscribing users and a supplier cache can be reduced).

A content assignment may be prioritized by a CPC, a policy server, or a combined CPC and policy server. The content assignment may be prioritized by considering whether a cache is a main or a voluntary cache. The content assignment may be prioritized based on a time remaining before a promised start time (e.g., such as a video start time). For example, contents to be fetched to a main supplier cache may be given a higher priority. Contents with less remaining time before the promised start time may be given a higher priority.

A cooperative content caching, determined by a CPC, a policy server, or a combined CPC and policy server, may determine a pre-fetching period (e.g., a period when the content is allowed to be fetched from the network). The cooperative content caching may determine a pre-fetching bandwidth (e.g., how fast the content is allowed to be fetched from network). The cooperative content caching may determine the pre-fetching period and/or the pre-fetching bandwidth based on one or more of a backhaul capacity, a latency to one or more subscriber clients, a peak time table and/or a priority of the content.

Regulated intelligent pre-fetching of policy requested content may be provided (e.g., only when a minimum burden (e.g., above a threshold) is posed to a backhaul connection), determined by a CPC, a policy server, or a combined CPC and policy server. A user request may be accommodated in association with caching content at one or more nearby neighboring caches (e.g., when unused residual capacity is available).

The policy-driven edge cache content placement and/or retrieval may be applicable to the L3 application layer.

Optimization of proxy caching, by a CPC, a policy server, or a combined CPC and policy server, may be provided/determined under one or more constraints such as a backhaul bandwidth and/or a storage space. The optimization of proxy caching may be provided/determined in conjunction with a time constraint (e.g., in order to define a most cost-efficient way to perform content placement in a generic policy-driven content distribution model), by a CPC, a policy server, or a combined CPC and policy server. A large number of contents may be requested by policy clients with varying policy profiles. Optimization of proxy caching, determined by a CPC, a policy server, or a combined CPC and policy server, may determine which content is to be fetched to which cache based on one or more of a backhaul bandwidth, a policy start time, a latency to subscriber clients, and/or a cache storage space.

Optimization of proxy caching, determined by a CPC, a policy server, or a combined CPC and policy server, may include one or more of a main supplier cache selection, a pre-fetching period definition, a bandwidth definition, and/or a content prioritization.

A main supplier cache selection/determination by a CPC, a policy server, or a combined CPC and policy server, may be defined as a reduction (e.g., a minimization) of an average latency of one or more subscriber requests. The main supplier cache selection/determination may be subject to a caching capacity and/or one or more backhaul bandwidth constraints. One or more policy requests may be accommodated by selecting/determining a compulsory main supplier cache. The compulsory main supplier cache may be close to one or more (e.g., most) of the potential access clients. Policy content may be available to the potential access clients during the retention period. A candidate supplier cache may receive a policy request. The candidate supplier cache may calculate an average latency to one or more (e.g., all) access clients. If the residual capacity and/or backhaul bandwidth is available, a candidate supplier cache with the lowest average latency may be selected/determined, by a CPC, a policy server, or a combined CPC and policy server, as the main supplier cache.

A pre-fetching period and/or a bandwidth definition may be used, by a CPC, a policy server, or a combined CPC and policy server, to ensure that the pre-fetching activity occurs at a (e.g., the most) resource-friendly time (e.g., with controlled pre-fetching bandwidth rather than pre-fetching the content immediately once received the request). For example, pre-fetching may be performed (e.g., aimed) at a minimum usage of backhaul during a peak time. A historical peak time knowledge and/or available backhaul bandwidth may be used to determine when to perform pre-fetching.

Content prioritization, determined by a CPC, a policy server, or a combined CPC and policy server, may include prioritizing content (e.g., the to-be pre-fetched content). Content prioritization may favor a main supplier and/or content with less time left than a policy start time. Prioritized contents may be regarded as having more urgent pre-fetching demands than other content. Prioritized content may be provided/determined to have more pre-fetching bandwidth and/or an earlier pre-fetching time than the other content.

A policy-driven content distribution system and/or collaborative edge caching may provide resource-aware content placement over one or more edge cache servers in the network. The policy-driven content distribution system and/or collaborative edge caching may allow more optimal usage of cache storage. The policy-driven content distribution system and/or collaborative edge caching may allow a regulated time to perform content pre-fetching. The policy-driven content distribution system and/or collaborative edge caching may allow higher utilization on backhaul resources (e.g., via solving one or more constraint-based decision making problems).

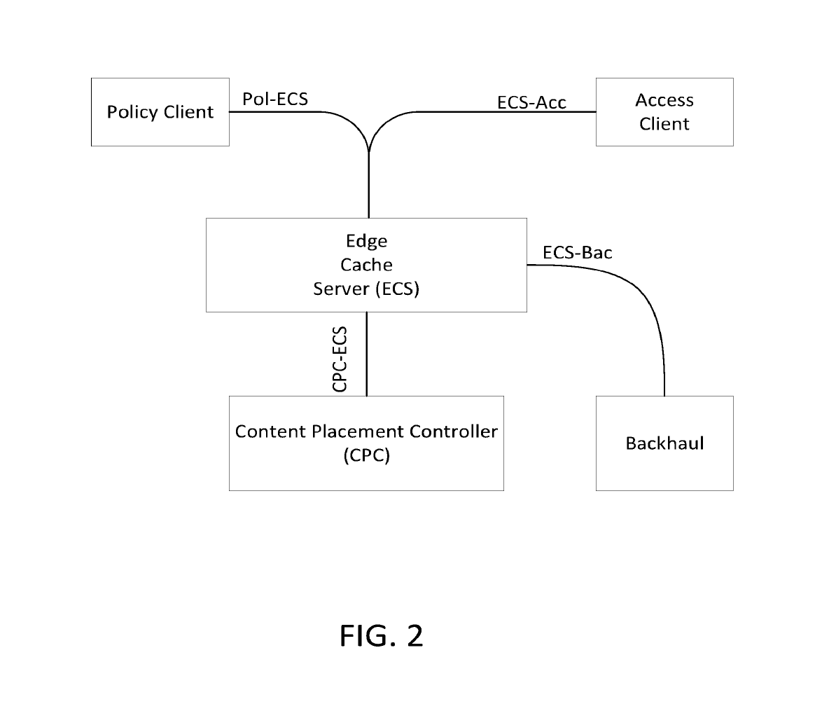

FIG. 2 depicts an example policy-driven system architecture. The example policy-driven system architecture may include one or more components such as a policy client, an access client, an edge cache server (ECS) or multiple ECSs, a content placement controller (CPC), and/or a backhaul. Although FIG. 2 depicts the policy client and the CPC as separate entities, the policy client and the CPC may be combined into one entity. The policy client is, for example, a server(s) that a user can access to provide a policy. The policy client has one or more processors that are configured or has executable instructions to perform the functions described herein. The CPC is a for example a server(s) with one or more processors that is configured or has executable instructions to perform the functions described herein. The example policy-driven system architecture may include one or more interfaces such as a Pol-ECS interface, an ECS-Acc interface, an ECS-Bac interface, and/or a CPC-ECS interface. A policy request may be submitted by the policy client to the ECS. The policy client may determine that an policy request has been submitted and determine that a policy request should be sent to the ECS or CPC. For example, the policy client may send a policy request when one or more upcoming events require specific content to be available (e.g., present) in the fronthaul network. The policy client may determine to/send a policy request when one or more upcoming school lessons that require specific teaching material to be present in the fronthaul network. The policy client may determine to/send a policy request when one or more upcoming schedules in a program (e.g., broadcast program) require specific content to be present in the fronthaul network. The policy request may be determined to be received/received by the CPC. Upon receiving the policy request, the CPC may determine a parameter for the content pre-fetching. Content may be pre-fetched at a predefined time from the backhaul network to one or more local caches at the ECS. The pre-fetched contents may be accessed by one or more access clients (e.g., during a requested retention time period). An access client may send a content request (e.g., an HTTP request) for content to the ECS. The ECS may send cached content to the access client in response to the content request. The backhaul may be a server or network (e.g., satellite system) that stores or distributes content.

The Pol-ECS interface may be defined as an interface between a policy client and an ECS. The policy client may receive and/or confirm a policy request via the Pol-ECS interface or determine that the policy request has been received and/or determine to confirm the request. The ECS may receive and/or confirm a policy response via the Pol-ECS interface. The Pol-ECS interface may enable transmitting a policy in terms of, for example, a requested cache storage, a retention period, one or more URL sets, one or more allowed access clients and/or the like.

A policy request may be sent via a simple web form to the policy client. The simple web form may be hosted in a web server (e.g., at the edge cache itself or at any other server in the network). A policy request may be search-based. A search-based policy request may include a web-based dialog that provides a search-like experience (e.g., based on a human-readable search term input). Content (e.g., desired content) may be selected (e.g., by a user) and determined be selected by the policy client upon receipt of the policy request. A confirmation button may be provided. A pre-fetching policy may be sent (e.g., upon selection of the confirmation button) with the selected content as the basis for the URL set of the pre-fetching policy by the user to the policy client and the policy client may determine that the pre-fetching policy has been received. The search-based policy request may be provided within a catalogue of content (e.g., such as an educational catalogue). The desired content (e.g., teaching material) may be selected from the catalogue of content by the user and be determined to be selected by the policy client. The desired content may provide a basis for the URL set of the pre-fetching policy.

A confirmation response may be a separate, e.g., php-based, web page. The confirmation response may include (e.g., confirm) the policy data requested. The policy client may provide the confirmation response to the user. The requested policy data may be stored/retrieved (e.g., to a local temporary file for proxy reconfiguration) by the policy client. The requested policy data may be sent in compliance with a web service from the user to the policy client and/or from the policy client to the CPC

The CPC-ECS interface may be defined as the interface between a CPC and an ECS (e.g., to apply the instructions received from the CPC). The CPC-ECS interface may be used to send the received policy data from the policy client to the CPC. The CPC-ECS interface may be used to send an acknowledgement from the CPC to the ECS (e.g., when a pre-fetching request is received). The CPC-ECS interface may be used to send network side data as derived from ECS (e.g., such as the backhaul bandwidth, average latency, and/or the like) to the CPC. The CPC-ECS interface may be used to send a calculated pre-fetching period/bandwidth from the CPC to the ECS. The CPC-ECS interface may be provided in accordance with a web service compliant realization (e.g., based on Javascript or PHP-based interactions).

The ECS-Bac interface (e.g., an outbound direction of the ECS-Bac interface) may be used to send one or more HTTP pre-fetching requests. The ECS-Bac interface (e.g., an inbound direction of the ECS-Bac interface) may be used to download data from a source. The backhaul link may include satellite technology. A normal HTTP request may be used as a pre-fetch technique. Using the normal HTTP request as a pre-fetch technique may enable the pre-fetching to function at the same time as other equipment and solutions in the network (e.g., specifically the backhaul, that aims for network utilization improvements, such as Performance Enhancing Proxies (PEP) or general web request batching solutions). The backhaul may include usage of one or more Information-centric Networking (ICN) solutions for the transfer of one or more HTTP and/or underlying IP requests. Transparent usage of the one or more HTTP requests may benefit from associated improvements. Two or more edge caches may retrieve the same content. The same content may be multicast (e.g., rather than as two separate unicast transmissions).

The ECS-Bac interface may be used for reporting a backhaul bandwidth and/or other network information (e.g., as requested by the ECS). The ECS-Bac interface may be between the ECS and an SNMP-compliant management information base (MIB) database-like structure. The SNMP-compliant MIB may be hosted at a satellite control center (e.g., in the case of satellite backhaul networks). One or more retrieval delays and/or bandwidth usage for blocks of HTTP requests may be determined (e.g., estimated) using one or more PEPs and/or radio resource management level information.

The ECS-Acc interface may be defined as the interface between an ECS and an access client. The ECS-Acc interface may be used to receive one or more (e.g., instantaneous) latency measures of the interface at the access client side. The ECS-Acc interface may be used to perform content retrieval from the ECS towards the access client. A link measurement (e.g., one or more round trip time measurements) and/or one or more MIB-based retrievals may be provided (e.g., for cases where such measurements are available from a MIB-like database structure). The content retrieval from the ECS towards the access client may include a standard proxy-based HTTP retrieval. The standard proxy-based HTTP retrieval may be realized transparently (e.g., with the proxy working in interception mode). The standard proxy-based HTTP retrieval may be performed through configuration of the proxy in the browser settings of the user.

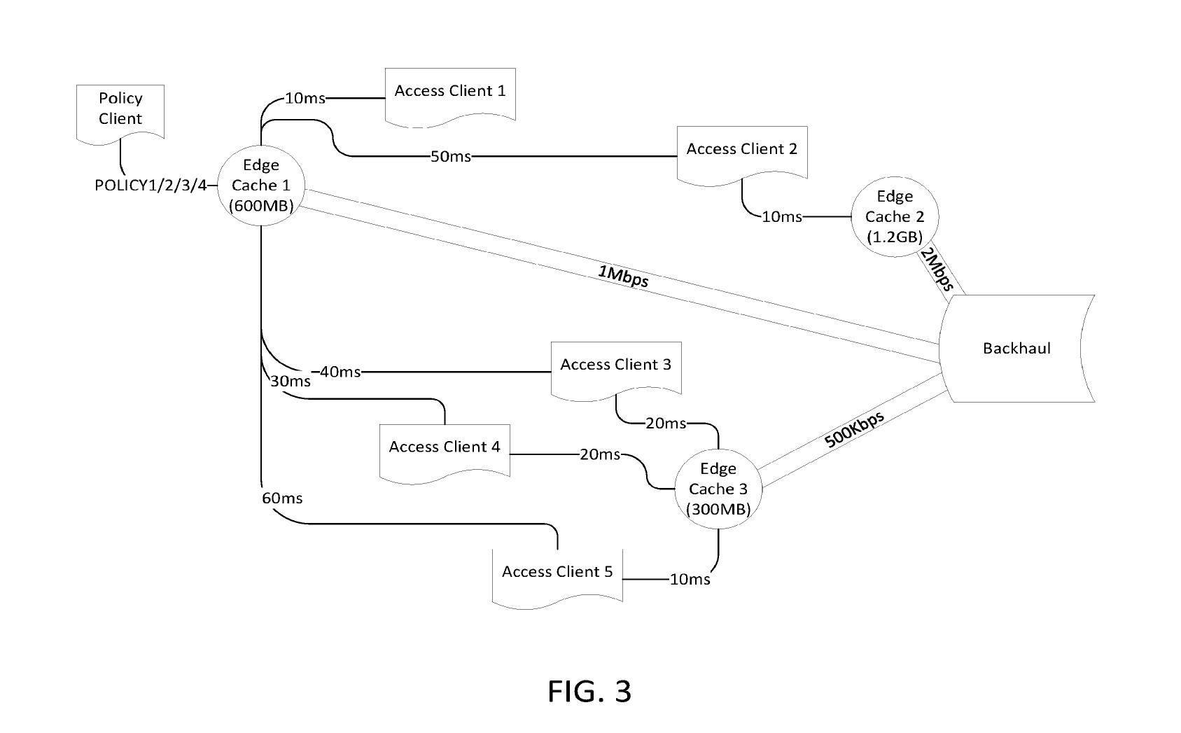

FIG. 3 depicts an example policy-driven edge content placement. One or more clients may access the policy content via one or more edge servers (e.g., with different path routes). The backhaul bandwidth and unused storage of a first cache server may be different than the backhaul bandwidth and unused storage of a second cache server. The backhaul bandwidth and unused storage associated with a cache server may change over time. A main cache may be selected (e.g., depending on the policy) by the CPC, policy client, or combined CPC/policy client. A content pre-fetching rule (e.g., optimal content pre-fetching rule) may be defined (e.g., by assigning different refreshment patterns to one or more cache servers) by the CPC, policy client, or combined CPC/policy client. One or more of the following may apply to cooperative content caching.

An edge cache with a low (e.g., the shortest) average latency may be assigned as a main content cache, by the CPC, policy client, or combined CPC/policy client. For example, as shown in FIG. 3, a policy from a policy client may define an access client list (e.g., such as {access client 3, access client 4, access client 5}). One or more (e.g., all) edge caches may receive a policy request. The one or more edge caches (e.g., EC1, EC2, EC3) may calculate an average latency to one or more intended access clients as:
from EC1: the average latency between EC1 and access client 3,4,5 (40 ms+30 ms+60 ms)/3=43.33 ms
from EC2: the average latency between EC2 and access client 3,4,5 (40 ms+50 ms+60 ms)/3=50 ms
from EC3: the average latency between EC3 and access client 3,4,5 (20 ms+20 ms+10 ms)/3=16.67 ms
   The average latency may be provided to the by the CPC, policy client, or combined CPC/policy client. An edge cache (e.g., EC3) of the one or more edge caches may be selected/determined as the main content cache (e.g., because it has the lowest latency to the one or more intended access clients) by the CPC, policy client, or combined CPC/policy client. The remaining edge caches (e.g., EC1 and EC2) may be voluntary caches or determined to be voluntary caches by the CPC, policy client, or combined CPC/policy client. A voluntary cache may cache content when (e.g., only when) there is a residual capacity. A cache assignment may require prior and/or on-demand latency information between ECs and associated serving access clients and may the latency information may be used by the by the CPC, policy client, or combined CPC/policy client to make a cache assignment.

Policy content caching in a voluntary cache may complement the main cache. One or more of the following may apply to the design of voluntary cache for policy content placement by the CPC, policy client, or combined CPC/policy client. A content placement in a voluntary cache may be allowed or determined (e.g., when there is residual capacity available). A policy content stored in a voluntary cache may be (e.g., automatically) removed (e.g., when the used capacity is required by a normal user). The policy content may be accessible from a main cache (e.g., with a higher latency).

One or more backhaul constraints may be considered by the CPC, policy client, or combined CPC/policy client as a parameter in a cooperative caching design. One or more of the following may apply. Pre-fetching from a backhaul may be regulated (e.g., so that important content gets the priority it deserves). The policy content may be prioritized (e.g., based on the time left before the policy access start time) by the CPC, policy client, or combined CPC/policy client. The policy content may be made available to one or more access users (e.g., of the policy). A time allowed for policy content pre-fetching may be defined by the CPC, policy client, or combined CPC/policy client based on a current available bandwidth of the backhaul link. For example, as shown in FIG. 3, the available bandwidth for one or more edge caches may be defined and provided to the CPC, policy client, or combined CPC/policy client for determination of the prefetching time as follows:
EC1: 1 Mbps available bandwidth, making 600 Mbytes available in the next 10 minutes
EC2: 1 Mbps available bandwidth, making 1.2 Gbytes available in the next 10 minutes
EC3: 500 Kbps available bandwidth, making 300 Mbytes available in the next 10 minutes
   A total size of one or more (e.g., all) files to be pre-fetched in the policy. A first policy content with a total requested size larger than 600 Mbytes may be determined by the CPC, policy client, or combined CPC/policy client to be pre-fetched using EC2 if EC2 served as a main or voluntary caches (e.g., during the pre-fetching period). A second policy content with a total requested size larger than 300 Mbytes but less than 600 Mbytes may be determined by the CPC, policy client, or combined CPC/policy client to be pre-fetched using EC1 and/or EC2 if EC1 and/or EC2 served as main or voluntary caches (e.g., during the pre-fetched period). A third policy content with total requested size smaller than 300 Mbytes may be determined by the CPC, policy client, or combined CPC/policy client to be pre-fetched using one or more (e.g., all three) ECs if the one or more ECs served as main or voluntary caches. One or more files related to a single policy may be determined by the CPC, policy client, or combined CPC/policy client to be pre-fetched via different ECs at different times (e.g., based on the instantaneous backhaul bandwidth available to the different ECs). For example, a first policy may involve one or more (e.g., 5) files denoted as F1, F2, F3, F4, F5. The first policy may be determined by the CPC, policy client, or combined CPC/policy client to be pre-fetched to a main EC and one or more (e.g., 2) voluntary ECs. Table 1 provides an example of a backhaul—aware content pre-fetching during a time period of 3 hours, as determined by the CPC, policy client, or combined CPC/policy client.

TABLE 1
Backhaul-aware content pre-fetching example.

| File | EC1 | EC2 | EC3 |
|---|---|---|---|
| Hour 1 | F3 | F2 | F1 F4 F5 |
| Hour 2 | F5 | F1 F2 F3 F4 | NONE |
| Hour 3 | F4 | NONE | F1 F2 F3 F5 |

An EC may actively pre-fetch when an available backhaul bandwidth is large enough to complete a file download. The EC may be kept idle/determined to be kept idle by the CPC, policy client, or combined CPC/policy client if the available backhaul bandwidth is zero and/or less than the smallest file in the policy. A delay estimate and a bandwidth estimate may be retrieved via the ECS-Bac interface (e.g., over a satellite backhaul). The delay estimate and the bandwidth estimate may be utilized by the CPC, policy client, or combined CPC/policy client to determine a rank for one or more content pieces. One or more (e.g., all) files related to policy may be combined into a policy file pool as determined by the CPC, policy client, or combined CPC/policy client to be. One or more indices of the policy file pool may be maintained by an edge cache controller as determined by the CPC, policy client, or combined CPC/policy client to be. One or more (e.g., all) policy files may be assigned with a priority which can be customized, as determined by the CPC, policy client, or combined CPC/policy client to be. The priority may be customized by the CPC, policy client, or combined CPC/policy client to be as a decision making problem based on one or more metrics, e.g., whether this is a main/voluntary cache, an available storage, an available backhaul bandwidth and/or the time left before policy start time.

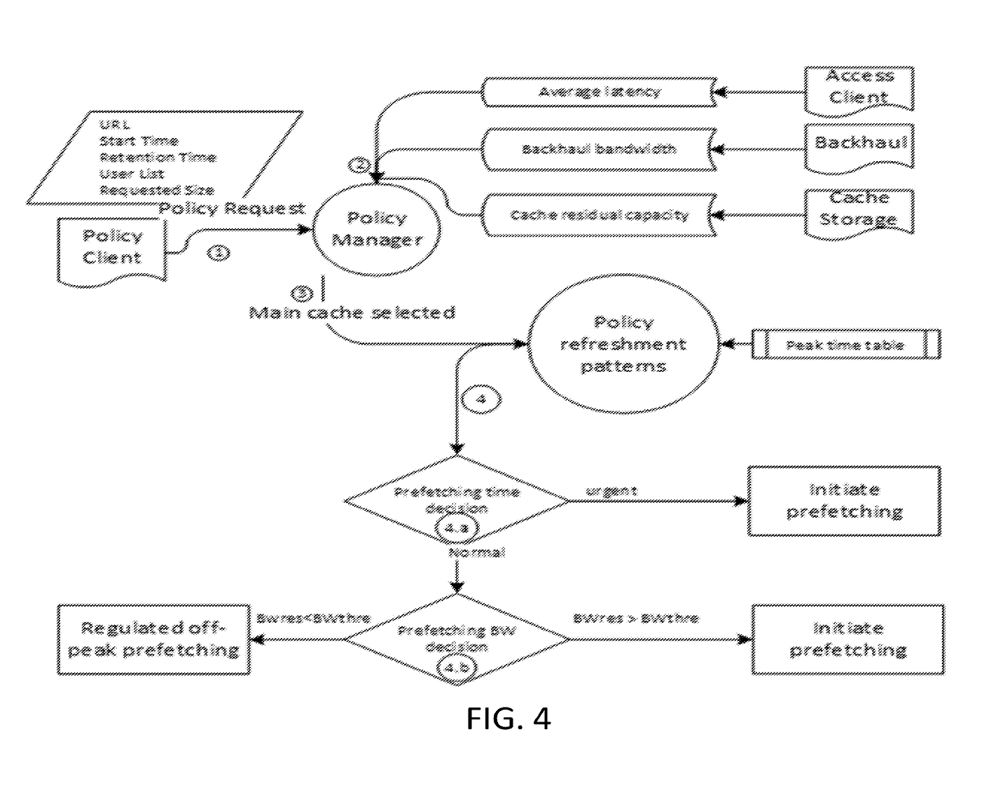

FIG. 4 depicts an example content placement. One or more of the following may apply to the example content placement. The Policy Client and Policy Manager of FIG. 4 may be separate entities/servers/processors or the same entities, servers/processors and may be the same as the CPC entity, server, and/or processor.

A policy client may submit a policy request to an edge cache. The policy request may include one or more of the following: URL, StartTime, RetentionTime, UserList, and/or RequestedSize. A policy request encoding may be represented as:

www.example.com:051020151200:10080:{sub1,sub2,sub3}:100M

A policy request encoding may include XML-based formats may be submitted to a policy client by a user. A policy client may receive or submit multiple requests and determine that to receive or submit the requests. Multiple clients may submit or receive one or more policy requests.

One or more measurements from an access client or edge server may be collected by a policy client or CPC. The one or more measurements may be sent to a policy client or a policy manager (e.g., to select the main and voluntary caches) and determined to be received by the determined by the policy client and/or policy manager. The policy manager may be the same as the policy client and/or the CPC. The one or more measurements collected from an access client or edge server may include an average latency to ECS. The one or more measurements collected from a backhaul by a policy client, policy manager, or CPC may include a backhaul bandwidth and/or a peak time table. The one or more measurements collected from a cache storage by a policy client, policy manager, or CPC may include a cache residual capacity. The policy client, policy manager, and/or CPC may have one or more processors configured to or programmed with executable instructions to determined that the measurements have been received and/or to store the measurements.

The one or more measurements may be collected by a policy client, policy manager, or CPC as a periodical reporting. The data retrieval by a policy client, policy manager, or CPC may be performed on demand from a local database (e.g., when called from the policy manager, policy client, and/or CPC).

The one or more measurements may be collected by a policy client, policy manager, or CPC as an on-demand data collection and reporting. For example, an information request may be sent to (e.g., only to) and determined to be sent to the requested access clients and backhaul network upon receiving a specific policy request. The interface may remain in an idle status if there is no policy request.

A main cache may be selected by a policy client, policy manager, or CPC based on one or more of the following: a policy requested cache size, a cache residual capacity, a backhaul bandwidth, an average latency to one or more (e.g., all) requested access clients, and/or a peak time table.

One or more policy refreshment patterns may be determined by a policy client, policy manager, or CPC based on a pre-fetching time, a pre-fetching bandwidth, and/or a historical peak time table.

A pre-fetching time may include the time allowed for starting the content pre-fetching. The pre-fetching time may be determined by a policy client, policy manager, or CPC based on one or more of the following: ‘Min’ may include the time (e.g., in minutes) that an object without an explicit expiry time may be considered fresh. A recommended value for ‘min’ is 0. Higher values than 0 for ‘min’ may cause a dynamic application to be erroneously cached (e.g., unless the application designer has taken the appropriate actions); ‘Percent’ may include a percentage of the objects age (e.g., the time since a last modification age). For example, an object without an explicit expiry time may be considered fresh; or ‘Max’ may include an upper limit on how long an object without an explicit expiry time may be considered fresh. A rule for determining the pre-fetching time may allow (e.g., only allow) content pre-fetching when a network is free (e.g., during off-peak time). The policy client, policy manager, or CPC may determine the pre-fetching time by considering one or more of the network free time, the “min,” “percent,” and “max.” Policy-based content may not be required or be determined not to be required until a predefined StartTime. A content placement may not impact normal user service (e.g., as long as the content is available before the StartTime).

A pre-fetching bandwidth may be defined as the maximum bandwidth allowed for content pre-fetching. The pre-fetching bandwidth may be determined by a policy client, policy manager, or CPC based on one or more of the following constraints (e.g., limitation or objective): a cache storage size, a backhaul bandwidth, minimizing the backhaul bandwidth burden, and/or minimizing the fronthaul user latency. There may not be a requirement for how fast the policy-based content is to be fetched. The policy-based content may be fetched at a speed that is lower than an available backhaul bandwidth. One or more design rules may be determined or received for defining the pre-fetching bandwidth by a policy client, policy manager, or CPC. A predefined threshold bandwidth may be determined by a policy client, policy manager, or CPC. If the residual bandwidth is lower than the predefined threshold bandwidth, the pre-fetching bandwidth may be set to zero and/or the content may follow a regulated off-peak pre-fetching by a policy client, policy manager, or CPC. A percentage of a residual bandwidth may be assigned for pre-fetching by a policy client, policy manager, or CPC. The percentage of residual bandwidth assigned for pre-fetching may leave a safe gap bandwidth for normal service. The percentage of the bandwidth for pre-fetching may be set to change dynamically (e.g., to adapt to the traffic dynamics) by a policy client, policy manager, or CPC. Policy pre-fetching may not occupy the bandwidth used for normal service.

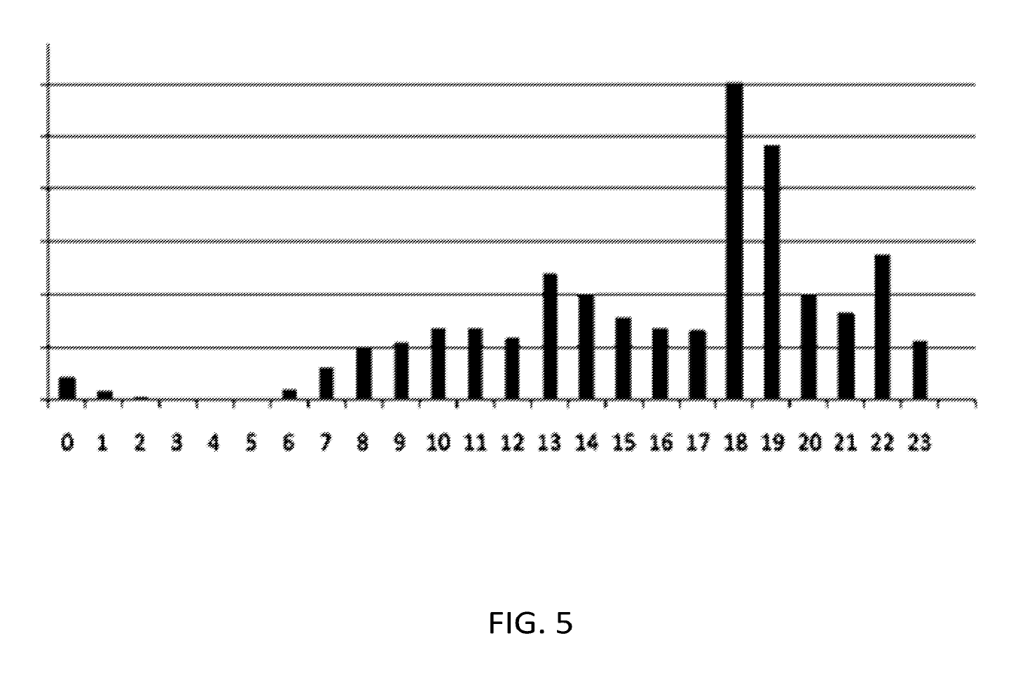

FIG. 5 depicts an example historical peak time table for a policy-driven caching design. The horizontal axis is time in hours for a day based on twenty-four hours in a day. The vertical axis is the amount of bandwidth used in the hour. For example, the peak time in FIG. 5 is at the 18^{th} hour in the day (e.g., 6 pm-7 pm). A pre-fetching policy may be set or determined based on a historical peak time table by a policy client, policy manager, or CPC. Calculation of one or more pre-fetching metrics (e.g., the pre-fetching time and/or the pre-fetching bandwidth) may be regulated considering the dynamics in the backhaul traffic (e.g., using a historical peak time table). A historical peak time table may be updated from measuring the backhaul link periodically. The historical peak time table may be stored in the ECS and provided to the policy client, policy manager, and/or CPC. A policy based content pre-fetching event that is not approaching its deadline (e.g., more than a 1 day) may be associated with an off-peak timeslot (e.g., regulated off-peak pre-fetching).

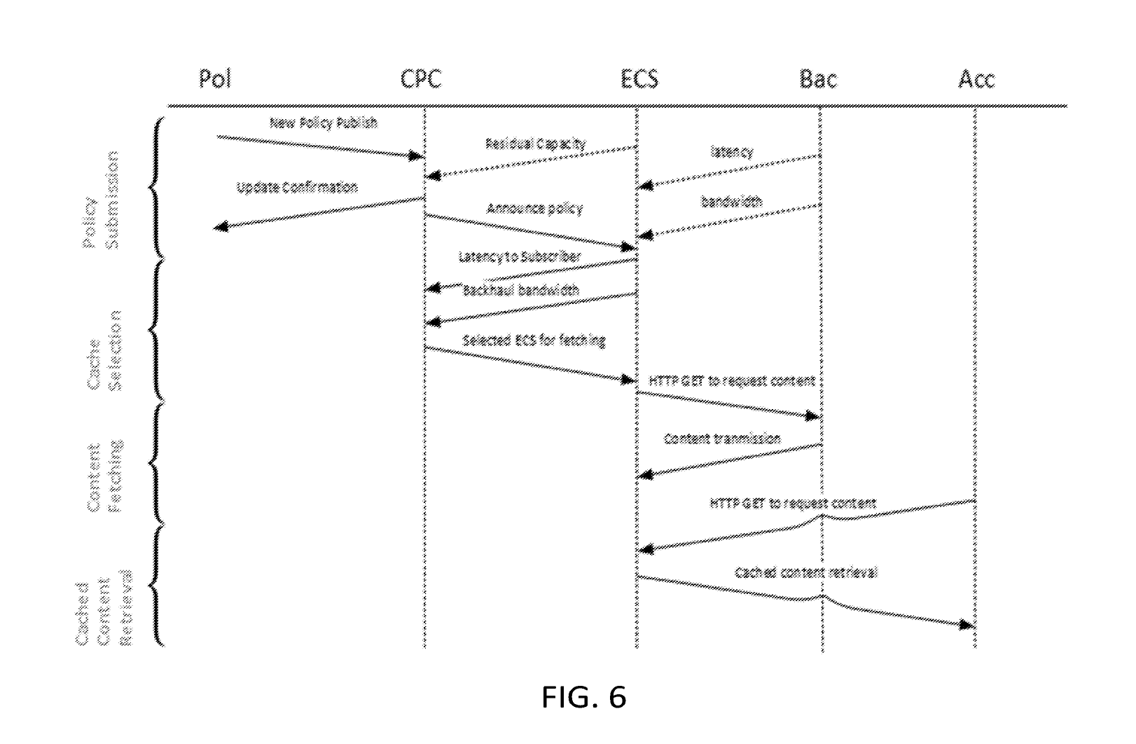

FIG. 6 depicts an example operational message exchange of cooperative content. An operational message exchange may include information exchange between a policy client (Pol), an access client, a CPC, an ECS, a Backhaul (BCS), and/or an access client (Acc). The operational message exchange may include one or more phases such as policy submission, cache selection, content pre-fetching, and/or cached content retrieval. FIG. 6 depicts an example where the CPC and policy client are separate entities and the CPC performs the cache selection. It is to be understood however that the policy client can received the edge server data (e.g., latency, bandwidth, etc. . . . ) and determine the edge servers and pre-fetching time and/or the policy client and the CPC may be the same entity.

In a policy submission phase, a policy may be submitted by a policy client. The policy may be received by the CPC. An unused residual capacity of the cache together with an average latency to subscribers may be made available during the policy submission phase.

In a cache selection phase, a main and/or one or more voluntary caches may be selected (e.g., using the derived refreshment patterns defining the pre-fetching time and bandwidth for the content) by the CPC, as shown in FIG. 6, or by a policy client or combined policy client/CPC.

In a content pre-fetching phase, the requested policy content may be pre-fetched to the selected main cache and/or one or more voluntary caches. The requested policy content may be pre-fetched based on the predefined refreshment patterns (e.g., via a standard http request).

In a cached content retrieval phase, one or more access clients may request the content during a retention time. The content may be retrieved and determined to be received from the main and/or one or more voluntary caches with the shortest path (e.g., rather than retrieving via the backhaul connectivity) by the policy client, CPC, and/or combined policy client/CPC.

Policy-driven content caching and/or pre-fetching may be performed in a teacher-pupil model.

For example, a local community school may be a policy client. The local community school may provide one or more distance learning courses to one or more pupils. The one or more pupils may include one or more access clients. A teacher may submit a policy request (e.g., in terms of a group of URL pages hosted somewhere in the Internet from an online form) to a policy client. The teacher may allow a predefined pupil group to access the online material (e.g., data) in a given period of time in the content request to the policy client. One or more backhaul constraints in a teacher-pupil model may include the backhaul bandwidth (e.g., because the school may be paying for the data used) used in the policy client. The one or more backhaul constraints in the teacher-pupil model may include the cache storage (e.g., because caching servers are expensive) used in the policy client. The data may be determined to be pre-fetched into a dedicated cache (e.g., during the off-peak time based on the policy refreshment patterns derived) by the policy server, CPC, or combined policy client/CPC. The data may be determined to be pre-fetched into one or more local edge servers as a Main cache and/or one or more voluntary cache servers (e.g., when residual capacity are available from neighboring servers). A pupil (e.g., an authorized subscriber pupil) may access the data (e.g., until the course expiry date when the data may be removed from the server) from the one or more edge servers as determined by the policy server, CPC, or combined policy server/CPC. A school authority may subsidize the overall backhaul connectivity, save expensive bandwidth and/or storage costs (e.g., while providing a policy-based access to preloaded content to the teacher and the one or more pupils). The policy-based access to preloaded content may utilize the unused/residual capacity of the backhaul to retrieve the data as determined by the policy server, CPC, or combined policy server/CPC.

Policy-driven content caching and/or pre-fetching may be performed in a business headquarters-subsidiaries model.

For example, a computing system for a marketing team from a company headquarters (e.g., such as amazon.com) may be a policy client. The marketing team may identify a product category (e.g., that may include hundreds of new products for investment in a market). The marketing computing system (e.g., policy client) team may publish one or more (e.g., all) URLs (e.g., related to the product category) to one or more local subsidiaries in the market as access clients for production and/or sales. The company headquarters (e.g., policy client) may publish a request of one or more (e.g., hundreds of) URL pages with the related product information with one or more (e.g., tens of) authorized subsidiary lists, including the URLs, start time, retention time and/or the allowed user lists (e.g., IP addresses of the subsidiaries). One or more backhaul constraints in the business headquarters-subsidiaries model (e.g., policy client computing system) may include the costs incurred for renting one or more edge servers and/or the storage required for storing the content during the retention time. The average latency between a selected cache server and a company subsidiary may be less than a latency between the company subsidiary and the backhaul, as determined or known by the policy client. Using the selected cache server may, for example, improve response time, impact the production efficiency, and/or impact the final sales. One or more edge servers (e.g., near the one or more local subsidiaries) may be selected by the policy client, CPC, and/or combined policy client/CPC as a main and/or a voluntary supplier cache (e.g., for pre-fetching the contents). Policy-driven content caching and/or pre-fetching may consider cost and/or timely fulfillment as considered by the policy client, CPC, and/or combined policy client/CPC. Policy-driven content caching and/or pre-fetching may include regulated off-peak pre-fetching (e.g., for the next day content fulfillment to the one or more local subsidiaries) by the policy client, CPC, and/or combined policy client/CPC. The company headquarters (e.g., policy client computing system) may determine to use the residual bandwidth to push (e.g., proactively) content to one or more edge caches (e.g., for an improved QoE at the point of sales).

Each of the computing system described herein, such as the policy client, CPC, and the edge severs, may have one or more computer processors having memory that are configured with executable instructions or hardware for accomplishing the functions described herein including determining the parameters described herein and sending and receiving messages between entities.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1. A method of managing content caching from a plurality of edge servers, the method comprising:
receiving a content request;
determining a policy, for access clients to retrieve the requested content, from the plurality of edge servers, based on one of a requested cache storage, a retention period for the requested content, a URL for the requested content, and the access clients for the requested content;
receiving, from each of the plurality of edge servers, latency data, a backhaul bandwidth, a peak usage time, and a residual storage capacity for the respective edge sever;
determining to store the requested content on at least one of the plurality of edge servers based on at least one of the determined policy, the received latency data, the received backhaul bandwidth, the received peak usage time, a historical peak data usage over time of day, and the received residual storage capacity;
determining a prefeteching time, for the at least one of the plurality of edge servers that was determined to store the requested content, to prefetch the requested content, from a server or network; and
determining a prefetching bandwidth, for the at least one of the plurality of edge servers that was determined to store the requested content, to prefetch the requested content from the server or network.

2. canceled

3. canceled

4. The method of claim 1, wherein receiving a content request; determining a policy for access clients; receiving from each of the plurality of edge servers; determining to store the requested content; determining a prefetching time; and determining a prefetching bandwidth, take place within a computing system that is not a content placement controller.

5. The method of claim 1, further comprising determining that one of the plurality of edge servers is a main content cache server for the access clients and one or more of the plurality of edge servers is a voluntary content cache for the access clients.

6. The method of claim 5, further comprising determining that the main contact cache sever is the edge server in the plurality of edge severs that has a shortest average latency among the plurality of edge servers.

7. The method of claim 1, further comprising determining a refreshment profile, for the at least one of the plurality of edge servers that was determined to store the requested content, based on at least one of a number of users, a requested size, a cache size, one or more backhaul resources, a latency of one or more subscriber clients, a historical peak time table, and/or requests to download the requested content.

8. The method of claim 1, further comprising, for each access client, determining to store the requested content on at least one of the plurality of edge servers based on at least one of the determined policy, the received latency data, the received backhaul bandwidth, the received peak usage time, a historical peak data usage over time of day, and the received residual storage capacity; determining a prefetching time, for the at least one of the plurality of edge servers that was determined to store the requested content, to prefetch the requested content, from a server or network; and determining a prefetching bandwidth, for the at least one of the plurality of edge servers that was determined to store the requested content, to prefetch the requested content from the server or network.

9. The method of claim 1, further comprising determining a prefetching time is based on an available backhaul bandwidth for the at least one of the plurality of edge servers that was determined to store the received content.

10. The method of claim 1, wherein determining a prefetching bandwidth is based on at least one of backhaul bandwidth and cache storage size for the at least one of the plurality of edge servers that was determined to store the received content.

11. A computing system for managing content caching from a plurality of edge servers, comprising:
a processor configured to:
receive a content request;
determine a policy, for access clients to retrieve the requested content, from the plurality of edge servers, based on one of a requested cache storage, a retention period for the requested content, a URL for the requested content, and the access clients for the requested content;
receive, from each of the plurality of edge servers, latency data, a backhaul bandwidth, a peak usage time, and a residual storage capacity for the respective edge sever;
determine to store the requested content on at least one of the plurality of edge servers based on at least one of the determined policy, the received latency data, the received backhaul bandwidth, the received peak usage time, a historical peak data usage over time of day, and the received residual storage capacity;
determine a prefeteching time, for the at least one of the plurality of edge servers that was determined to store the requested content, to prefetch the requested content, from a server or network; and
determining a prefetching bandwidth, for the at least one of the plurality of edge servers that was determined to store the requested content, to prefetch the requested content from the server or network.

12. canceled

13. The computing system of claim 11, the computing system is a content placement controller.

14. The computing system of claim 11, wherein the computing system is not a content placement controller.

15. The computing system of claim 11, wherein the processor is further configured to determine that one of the plurality of edge servers is a main content cache server for the access clients and one or more of the plurality of edge servers is a voluntary content cache for the access clients.

16. The computing system of claim 15, wherein the processor is further configured to determine that the main contact cache sever is the edge server in the plurality of edge severs that has a shortest average latency among the plurality of edge servers.

17. The computing system of claim 11, wherein the processor is further configured to determine a refreshment profile, for the at least one of the plurality of edge servers that was determined to store the requested content, based on at least one of a number of users, a requested size, a cache size, one or more backhaul resources, a latency of one or more subscriber clients, a historical peak time table, and/or requests to download the requested content.

18. The computing system of claim 11, wherein the processor is further configured, for each access client, to determine to store the requested content on at least one of the plurality of edge servers based on at least one of the determined policy, the received latency data, the received backhaul bandwidth, the received peak usage time, a historical peak data usage over time of day, and the received residual storage capacity; determine a prefetching time, for the at least one of the plurality of edge servers that was determined to store the requested content, to prefetch the requested content, from a server or network; and determine a prefetching bandwidth, for the at least one of the plurality of edge servers that was determined to store the requested content, to prefetch the requested content from the server or network.

19. The computing system of claim 11, wherein the processor is further configured to determine a prefetching time based on an available backhaul bandwidth for the at least one of the plurality of edge servers that was determined to store the received content.

20. The computing system of claim 11, wherein the processor is further configured to determine a prefetching bandwidth based on at least one of backhaul bandwidth and cache storage size for the at least one of the plurality of edge servers that was determined to store the received content.

21. An edge server computing system, comprising:
a processor configured to:
determine latency data, a backhaul bandwidth for communicating with a network, a peak usage time, and a residual storage capacity;
determining to send the latency data, the backhaul bandwidth, the peak usage time and the residual storage capacity to a policy server;
determining from communications that the policy server has instructed the edge server computing system to store requested content on an edge server memory;
determine that the policy server has provided a prefeteching time to prefetch the requested content from the network; and
determining that the policy server had provided a prefetching bandwidth to prefetch the requested content from the network.

22. The edge server computing system of claim 21, wherein the processor is further configured to determine that the policy server has selected the edge server computing system as a main content contact cache server.

23. The edge server computing system of claim 21, wherein the processor is further configured to determine that the policy server has provided a refreshment profile for the requested content.
